(19) United States
(12) Patent Application Publication
(10) Pub. No.: US 2024/0364180 A1
(43) Pub. Date: Oct. 31, 2024

(54) TERMINAL RACK ASSEMBLY

(71) Applicant: GKN Automotive Limited, Birmingham, West Midlands (GB)

(72) Inventors: Alberto Peña Rodriguez, Zumaia (ES); Jon García Urbieta, Zumaia (ES); Oscar Baonza, Zumaia (ES); Aitor Tejado, Zumaia (ES)

(21) Appl. No.: 18/638,076

(22) Filed: Apr. 17, 2024

(30) Foreign Application Priority Data
Apr. 26, 2023 (DE) 10 2023 110 782.8
Apr. 15, 2024 (DE) 10 2024 110 495.3

(51) Int. Cl. H02K 5/22

(52) U.S. Cl. CPC H02K 5/225

(57) ABSTRACT

A terminal rack assembly for a stator of an electric machine comprises an insulating body, a plurality of electrical conductors having connection pads arranged to be connected to hairpin winding conductors of the stator, the plurality of electrical conductors forming at least one neutral conductor and multiple phase conductors, the phase conductors having connection members arranged to be connected to a current supply of the stator; to a stator of an electric machine comprises hairpin winding conductors.

### CROSS-REFERENCE TO RELATED APPLICATIONS

This application claims priority to German Patent Application No. DE 10 2023 110 782.8, filed on Apr. 26, 2023 and German Patent Application No. DE 10 2024 110 495.3, filed on Apr. 15, 2024, which applications are hereby incorporated herein by reference in their entireties.

### DESCRIPTION

The application refers to a terminal rack assembly for a stator of an electric machine, comprising an insulating body, a plurality of electrical conductors having connection pads arranged to be connected to hairpin winding conductors of the stator; to a stator of an electric machine comprising hairpin winding conductors and a terminal rack assembly; and to a process of manufacturing a terminal rack assembly.

US 2021/359568 A1⋅discloses a rotary electric machine, which includes a rotor and a stator. The stator has a coil end. The coil end has a plurality of lead wires. The plurality of lead wires have an inner lead wire with respect to the radial direction and an outer lead wire outside the inner lead wire with respect to the radial direction, wherein the inner lead wire and the outer lead wire of the same phase winding are arranged on the same diameter line of the stator core. The rotary electric machine includes a plurality of plate-shaped connection members. The inner lead wire and the outer lead wire are electrically and mechanically connected to the plurality of connection members. The plurality of connection members provide a heat transfer path from the inner lead wire.

EP 3 567 703 B1 discloses a stator for an electric machine, wherein the stator comprises a plurality of hairpin-type conductors, the hairpin-type conductors are connected to each other so as to form three stator windings. The stator comprises a plurality of current transmission elements for transmitting current, and each current transmission element is assigned to one stator winding. The stator comprises a connection element for connecting the stator windings to form a circuit, wherein the stator has insulating elements, wherein the connecting element is insulated on both sides in the axial direction of the stator by means of at least one insulating element, wherein at least one first insulating element is formed at a first axial end of the connecting element for insulation against the current transmission elements, and wherein at least one second insulating element is formed at a second axial end of the connecting element for insulation against end regions of the hairpin-type conductors.

US 2019/315031 A1 discloses a molded body comprising a first resin part and a metal part that is covered by the first resin part, wherein the metal part is a bus bar that is configured to electrically connect an external electric source and a coil of a rotary electric machine. The first resin part has a protrusion portion which protrudes from a first end portion of the first resin part and a second resin part has a second end portion which is positioned on an opposite side of the protrusion portion with respect to the first end portion in an extension direction of the protrusion portion and that covers the first resin part in a state where the first resin part protrudes in the extension direction. A portion of the first resin part is positioned between the first end portion and the second end portion formed in a flat surface. The first resin part separately covers each of a plurality of the metal parts and the second resin part covers collectively the first resin part. The first resin part is attached to the metal part.

WO 2021/191524 A1 discloses a connector for an external stator comprising an insulating support, an assembly of four electrical conductors having connection pads to the stator winding conductors and to a power supply bus of the stator, carried by the insulating support. The assembly of conductors has at least one neutral conductor oriented parallel to the axis of the stator and at least one conductor oriented perpendicular to the axis of the stator.

US 2020/287447 A1 discloses a stator for an electrical machine comprising a plurality of pins, which are arranged on at least two concentric circles, and an interface having at least one contact face which is connected to two electrically conductive legs and is supported by the legs, wherein the legs are connected to at least one pin on different concentric circles. By means of the legs on each side of the interface, the contact face is supported on the stator and thus makes it possible to provide a fixed point for connection of the phase conductors from an inverter. The pins are situated on a concentric circle in the inner region of the stator and on a concentric circle in the outer region of the stator. As the interface is connected to pins on merely outer and inner concentric circles, the pins on concentric circles therebetween are spanned by the interface. The legs have a twist between the pin and the contact face to maintain the insulation distances between the legs and other pins without compromising the stability of the legs.

WO 2021/025179 A1 relates to a stator assembly and a motor with this assembly. The stator assembly has a connecting ring including a lead wire, a lead wire bus bar and a neutral wire bus bar, wherein a support structure is provided for connecting the lead wire bus bar and the neutral wire bus bar to the stator coil and for supporting the connecting ring, the support structure comprising: a plurality of bus bar connecting parts connected to each of said lead wire bus bar and said neutral wire bus bar, and a wire connecting bus bar for connecting a plurality of wires, said wire connecting bus bar being connected to each of said plurality of bus bar connecting parts and connecting said plurality of conductor segments arranged in layers different from each other.

Terminal rack assemblies often comprise a high number of different parts, which renders the assembly process complex. Further, long neutral busbars tend to heat up to higher temperatures than the rest of the winding, limiting the current applicable. Besides, a misbalance in the currents can be a consequence.

An objective can be to provide a more compact terminal rack assembly for a stator of an electric machine.

According to an aspect, a terminal rack assembly for a stator of an electric machine comprises an insulating body and a plurality of electrical conductors having connection pads arranged to be connected to hairpin winding conductors of the stator. The connection members are designed in one piece with the respective phase conductor. The plurality of electrical conductors form at least one neutral conductor and multiple phase conductors, the phase conductors having connection members arranged to be connected to a current supply of the stator. The plurality of electrical conductors is carried by the insulating body, and it has a primary extension in a circumferential direction and a secondary extension in an axial direction, wherein the at least one neutral conductor and the phase conductors are arranged such as to overlap in a radial direction.

To overlap in a radial direction, the at least one neutral conductor and the phase conductors are arranged at least in part in axially and circumferentially coinciding positions. If the parts are in the same position in the axial direction and in the circumferential direction, they must be arranged next to each other, respectively at a distance from each other in the radial direction. The stator has a generally cylindrical form, which defines the axial, radial and circumferential directions with regard to the terminal rack assembly. Seen from a point on a longitudinal axis of the stator in the radial direction, a part of the neutral conductor lies in front of or behind the phase conductor. The overlapping arrangement of the at least one neutral conductor and the phase conductors as well as the arrangement of the integrally connected connection member directly on the phase conductors provides advantageously a compact design of the terminal rack assembly.

According to an embodiment, the phase conductors have phase conductor arms and the at least one neutral conductor has at least one neutral conductor arm, the phase conductor arms and the at least one neutral conductor arm being arranged in the same axial position and have the same extension in axial direction. The phase conductor arms can extend from the respective connection member in two opposite circumferential directions, two distal ends of the phase conductor arms each carrying one of the connection pads.

The phase conductors can be designed with the respective connection member as a stamped-bent part made of sheet metal. The connection member can have a lug, wherein the lug is angled in relation to the phase conductor arms, in particular by approximately 90°. The lug can thus extend in a plane to which the axial direction is perpendicular.

According to a further embodiment, the neutral conductor comprises at least two electrically separate neutral conductor arms. Additionally or alternatively, the neutral conductor comprises at least two neutral conductor arms, which are electrically connected at a bridge section. The bridge section and/or the separate neutral conductor arms advantageously allow the at least one neutral conductor and the phase conductors to be arranged such as to overlap in the radial direction. The bridge section can advantageously bridge over one of the phase conductor arms in the axial direction.

The arrangement of the at least one neutral conductor and the phase conductors overlapping in the radial direction advantageously allows the connection pads to be all arranged in the same axial position, thus enhancing the process of establishing connections to hairpin winding conductors of the stator by welding.

According to a further embodiment, the plurality of electrical conductors extend in the circumferential direction over an angle of less than 120°, preferably over an angle of less than 110°, and more preferably over an angle of about 106°. The reduced circumferential distribution further enhances the process of establishing the connections to the hairpin winding conductors of the stator by welding.

According to a further embodiment, the insulating body is a plastic moulding encasing the electrical conductors at least partially with openings on the conductor arms for the connection pads and on the connection members. The insulating body insulates the at least one neutral conductor and the phase conductors from each other and forms a rack carrier, which maintains their relative position.

According to a further aspect, a stator of an electric machine comprises hairpin winding conductors and a terminal rack assembly as described above, the hairpin winding conductors having a plurality of connection pins, wherein the connection pins are connected to the connection pads. The process of establishing these connections by welding is advantageously enhanced due to the compact design of the terminal rack assembly, as the welding machine, to reach all the welding spots, has to travel less far in axial and in circumferential direction.

According to a further embodiment, the connector pins all extend the same distance in the axial direction. With the connection all being arranged in the same axial position, the welding machine does not have to travel in axial direction at all between the welding spots.

According to a further embodiment, the hairpin winding conductors are arranged in slots of the stator, the connector pins being distributed circumferentially over a sector spanning less than one third of the slots. With the plurality of electrical conductors extending in the circumferential direction over an angle of less than 120°, the welding machine has to cover less than 120° in circumferential direction to reach all the welding spots.

According to a further embodiment, the hairpin winding conductors form multiple phases, wherein one of the phase conductors is provided per phase. With only one of the phase conductors per phase, the number of different parts of the plurality of electrical conductors is advantageously reduced. For example, for three phases, three different phase conductors and at least one neutral conductor are necessary. With the hairpin winding conductors forming at least two parallel branches per phase, each branch having a neutral connector pin and a phase connector pin at respective distal ends, then the neutral conductor may comprise at least two electrically separate neutral conductor arms, the at least two neutral connector pins of each phase being distributedly connected to the respective separate neutral conductor arms.

According to a further aspect, a process of manufacturing a terminal rack assembly as described above, comprises the steps of
forming the plurality of electrical conductors by stamping and bending of sheet metal, wherein the phase conductors are each formed in one piece with a connection member for connecting to a current supply of the stator;
arranging the at least one neutral conductor and the phase conductors such as to overlap in a radial direction; and
encasing the electrical conductors at least partially in the insulating body by plastic moulding.

The stator of an electric machine, the terminal rack assembly and the process of manufacturing a terminal rack assembly according to the invention is below described with reference to an exemplary embodiment as depicted in the accompanying drawings.

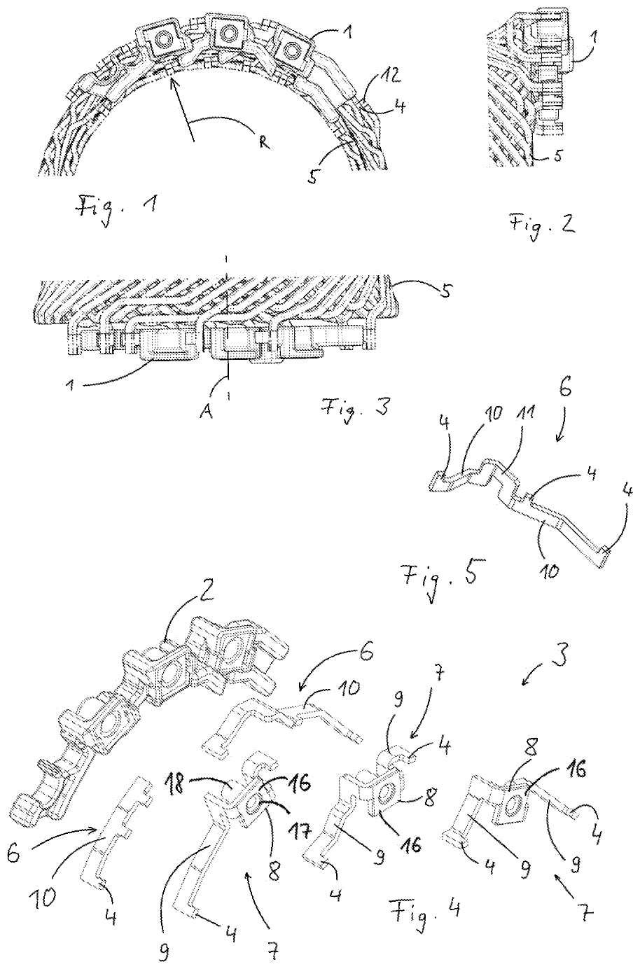

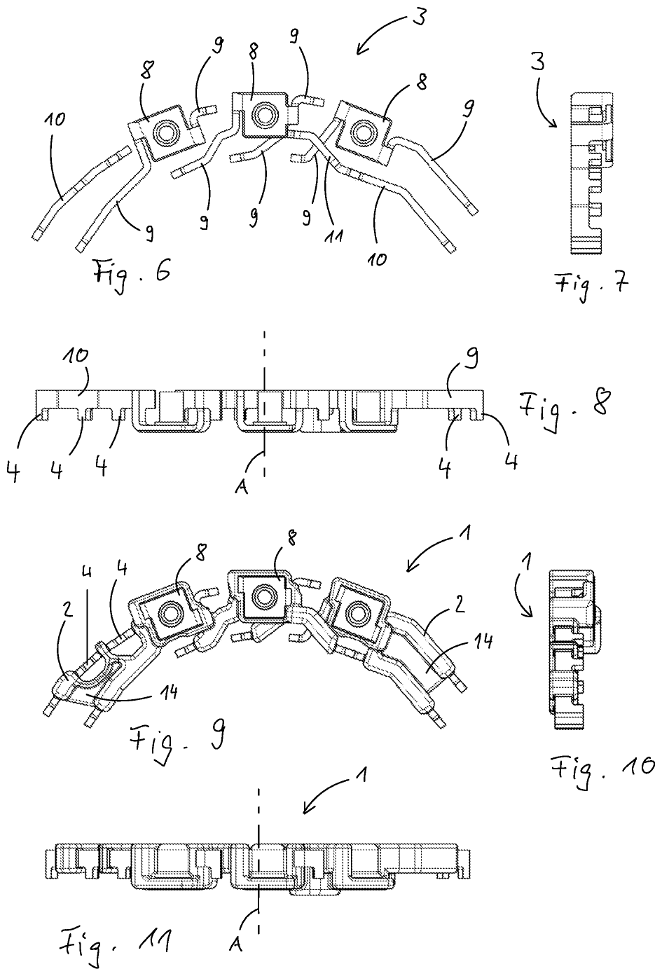

FIGS. 1 to 3 show an exemplary embodiment of the stator of an electric machine with a terminal rack assembly according to the invention in different views;

FIG. 4 shows the terminal rack assembly of FIG. 1 in an exploded view;

FIG. 5 shows a detail of FIG. 4 in a perspective view;

FIGS. 6 to 8 show a plurality of electrical conductors of the terminal rack assembly in three different views;

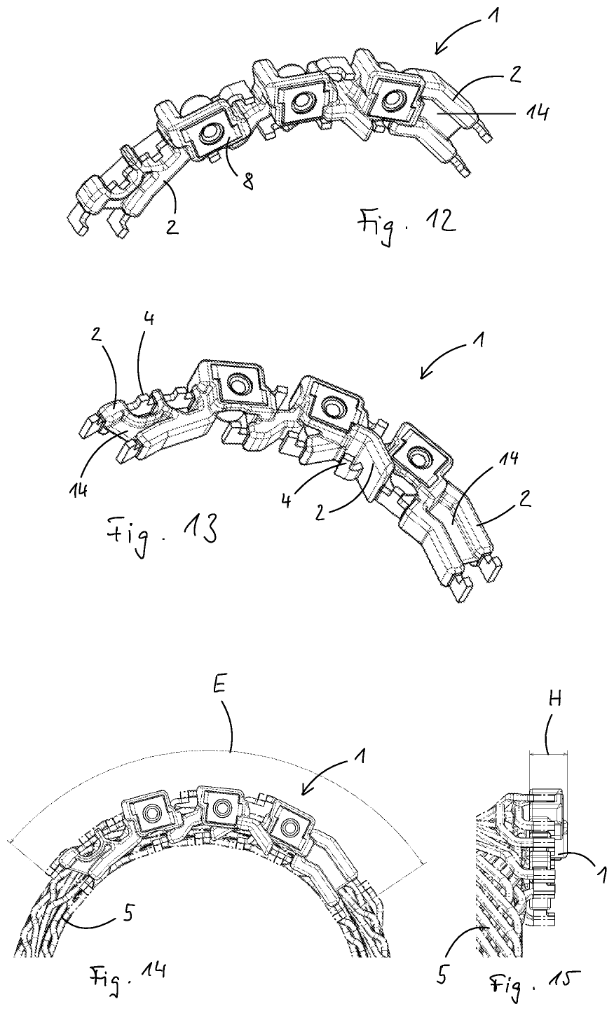

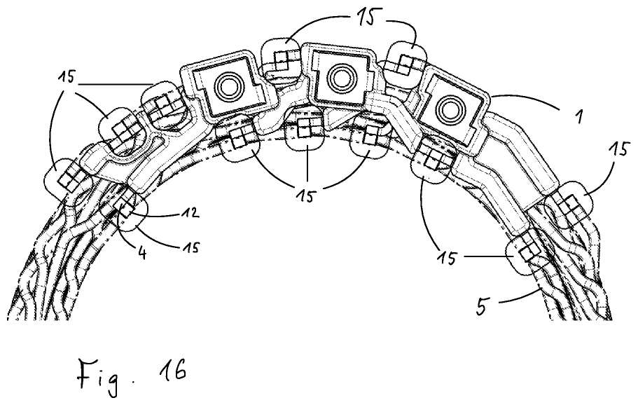

FIGS. 9 to 13 show the terminal rack assembly of FIG. 1 in different views;

FIGS. 14 and 15 show the stator of an electric machine of FIG. 1 in different views;

FIG. 16 shows the stator of an electric machine of FIG. 1 with indicated welding spots.

In FIGS. 1 to 3, an exemplary embodiment of the stator of an electric machine with a terminal rack assembly 1 is shown. The FIGS. 1 to 3 are described together. Of the stator, only hairpin winding conductors 5 and the terminal rack assembly 1 are depicted. Of the hairpin winding conductors 5, only a segment is depicted, i.e. the segment in which the terminal rack assembly 1 is arranged. The person skilled in the art is aware that the hairpin winding conductors 5 are generally arranged along the complete circumference of the stator. A longitudinal axis A of the cylindrical stator defines an axial direction. An arrow R represents a radial direction with respect to the longitudinal axis A. The longitudinal, axial and corresponding circumferential directions apply to the terminal rack assembly 1, irrespective of whether the stator or the hairpin winding conductors 5 are depicted or not.

In FIG. 4, the terminal rack assembly 1 of FIG. 1 is shown in an exploded perspective view. The terminal rack assembly 1 comprises the insulating body 2 and a plurality of electrical conductors 3 having connection pads 4 arranged to be connected to hairpin winding conductors 5 of the stator. The plurality of electrical conductors 3 of the illustrated embodiment form at least one neutral conductor 6 and three phase conductors 7, generally one per phase. The phase conductors 7 have connection members 8 arranged to be connected to a current supply (not depicted) of the stator. The phase conductors 7 have phase conductor arms 9 and the at least one neutral conductor 6 has at least one neutral conductor arm 10. The phase conductor arms 7 extend from the respective connection member 8 in two opposite circumferential directions. At each distal end of the phase conductor arms 7 is one of the connection pads 4 arranged. In the depicted embodiment, the neutral conductor 6 comprises two electrically separate neutral conductor arms 10. The phase conductor 7 with the respective connection member 8 is designed as a stamped-bent part made of sheet metal. The connection member 8 has a lug 16, wherein the lug 16 is angled relative to the phase conductor arms 9, in particular by approximately 90°. The lug 16 thus extends in a plane perpendicular to the axial direction. An aperture 17 for inserting a connection terminal (not shown) is provided in the lug 16, with a sleeve 18 for receiving the terminal extending in the axial direction, i.e. parallel to the phase conductor arms 9. Thus, the sleeve 18 of the connection members 8 with the neutral conductor 6 and the phase conductors 7 are also arranged to overlap in the radial direction. The sleeves 18 can be produced together with the aperture by a punching process in the manner of cup drawing or can be attached subsequently

With respect to FIG. 5, a detail of FIG. 4 is illustrated. FIG. 4 shows, in a perspective view, a part of the neutral conductor 6, which comprises two neutral conductor arms 10 electrically connected at a bridge section 11. The neutral conductor 6 thus comprises three neutral conductor arms 10, two of which are connected via the bridge section 11 and one being separate. The connected neutral conductor arms 10 carry three connection pads 4, one per phase, and the separate neutral conductor arm 10 carries three connection pads 4, also one per phase, to provide a floating neutral connection. The bridge section 11 and the separated neutral conductor arm 10 of FIG. 4 allow the neutral conductor 6 and the phase conductors 7 to be arranged such as to overlap in the radial direction. The bridge section 11 bridges over one of the phase conductor arms 9 in the axial direction, which will be further illustrated below.

In FIGS. 6 to 8, only the plurality of electrical conductors 3 of the terminal rack assembly 1 is shown in three different views. The top view of FIG. 6 illustrates the arrangement of the neutral conductor arms 10 and the phase conductor arms 9 in the radial and circumferential direction. The bridge section 11 crosses one of the phase conductor arms 9. The neutral conductor arms 10 and the phase conductor arms 9 have a primary extension in the circumferential direction, each two of the phase conductor arms 9 extending in opposite circumferential directions from one of the connection members 8. The side elevations of FIGS. 7 and 8 illustrate the arrangement of the neutral conductor arms 10 and the phase conductor arms 9 in the axial direction. The neutral conductor arms 10 and the phase conductor arms 9 have a secondary extension in the axial direction, and the neutral conductor arms 10 overlap with the phase conductor arms 9 in the radial direction. To overlap in the radial direction, the neutral conductor arms 10 and the phase conductor arms 9 are arranged in part in axially and circumferentially coinciding, and radially adjacent positions. The phase conductor arms 9 and the neutral conductor arms 10 are arranged in the same axial position and have the same extension in axial direction. In particular, the connection pads 4 are all arranged in the same axial position, thus enhancing the process of establishing connections to hairpin winding conductors 5 of the stator by welding. The overlapping arrangement of the neutral conductor 6 and the phase conductors 7 further provides advantageously a compact design of the terminal rack assembly 1 with reduced axial extension.

With regard to a process of manufacturing the terminal rack assembly 1, the plurality of electrical conductors 3 as shown in FIG. 5 comprises five differently shaped parts, which are formed by stamping and bending of sheet metal. The two parts forming the neutral conductor 6 and the three parts forming the three phase conductors 7 are arranged as illustrated in FIGS. 6 to 8, overlapping in the radial direction. The electrical conductors 6, 7 are then at least partially embedded in the insulating body 2 by plastic moulding to form the terminal rack assembly as shown in and further described with respect to FIGS. 9 to 13.

In FIGS. 9 to 13, which are described together, the terminal rack assembly 1 is shown in different views. The plurality of electrical conductors 3 comprising the neutral conductor 6 with neutral conductor arms 10 and the three phase conductors 7 with connection members 8 and phase conductor arms 9 is partly encapsulated and carried by the insulating body 2. The insulating body 2 is a plastic moulding encasing the electrical conductors 3 partially with openings on the conductor arms 9, 10 for the connection pads 4 and on the connection members 8. The insulating body 2 insulates the neutral conductor 6 and the phase conductors 7 from each other and forms a rack carrier with thin web portions 14, which maintain the relative position in the radial direction.

In FIGS. 14 and 15, the stator of FIG. 1 is shown in different views, illustrating the extension of the terminal rack assembly 1. Of the stator, only the hairpin winding conductors 5 and the terminal rack assembly 1 are depicted. Of the hairpin winding conductors 5, only a segment is depicted, i.e. the segment in which the terminal rack assembly 1 is arranged. The person skilled in the art is aware that the hairpin winding conductors 5 are generally arranged along the complete circumference of the stator. The plurality of electrical conductors 3 determines the extension in the circumferential direction over an angle E about 106°. A height extension H in axial direction may be less than 25 millimetres, preferably less than 20 millimetres and more preferably about 18 millimetres. The height extension H is determined by the axial extension of the bridge section 11 plus the insulating body 2 material disposed on the bridge section 11.

In FIG. 16, the stator of FIG. 1 is shown with indicated welding spots 15. The hairpin winding conductors 5 have a plurality of connector pins 12, which are connected to the connection pads 4 by welding, in particular by laser welding. The connector pins 12 all extend the same distance in the axial direction. With the connector pins 12 all being arranged in the same axial position, a welding machine (not depicted) does not have to travel in the axial direction at all between the welding spots 15. The process of establishing these connections by welding is advantageously enhanced due to the compact design of the terminal rack assembly 1. A welding machine reaches all the welding spots 15, which are advantageously arranged in the same axial position, distributed over about only 106° in the circumferential direction, and in two different radial positions.

### REFERENCE NUMERALS

1 Terminal rack assembly
2 Insulating body
3 Plurality of electrical conductors
4 Connection pads
5 Hairpin winding conductors
6 Neutral conductor
7 Phase conductors
8 Connection members
9 Phase conductor arms
10 Neutral conductor arms
11 Bridge section
12 Connector pins
14 Web
15 Welding spot
16 Lug
17 Aperture
18 Sleeve
E Angle of extension in circumferential direction
H Height extension in axial direction
A Longitudinal axis, axial direction
R Radius, radial direction

1.-15. (canceled)

16. A terminal rack assembly for a stator of an electric machine, comprising:
an insulating body;
a plurality of electrical conductors having connection pads arranged to be connected to hairpin winding conductors of the stator, the plurality of electrical conductors forming at least one neutral conductor and multiple phase conductors, the phase conductors each having a connection member arranged to be connected to a current supply of the stator, the connection members being provided in one piece with the respective phase conductor;
wherein the plurality of electrical conductors is carried by the insulating body;
wherein the plurality of electrical conductors has a primary extension in a circumferential direction and a secondary extension in an axial direction; and
wherein the at least one neutral conductor and the phase conductors are arranged to overlap in a radial direction.

17. The terminal rack assembly of claim 16, wherein the phase conductors with the respective connection member are stamped-bent parts made of sheet metal.

18. The terminal rack assembly of claim 16, wherein the phase conductors have phase conductor arms and the at least one neutral conductor has at least one neutral conductor arm, wherein the phase conductor arms and the at least one neutral conductor arm are arranged in the same axial position and have the same extension in axial direction.

19. The terminal rack assembly of claim 18, wherein the phase conductor arms extend from the respective connection member in two opposite circumferential directions, two distal ends of the phase conductor arms each carrying one of the connection pads.

20. The terminal rack assembly of claim 18, wherein the connection member has a lug, wherein the lug is angled relative to the phase conductor arms, in particular by approximately 90°.

21. The terminal rack assembly of claim 16, wherein the lug extends in a plane perpendicular to the axial direction.

22. The terminal rack assembly of claim 17, wherein the neutral conductor comprises at least two electrically separate neutral conductor arms.

23. The terminal rack assembly of claim 17, wherein the neutral conductor comprises at least two neutral conductor arms, which are electrically connected at a bridge section.

24. The terminal rack assembly of claim 23, wherein the bridge section bridges over one of the phase conductor arms in the axial direction.

25. The terminal rack assembly of claim 16, wherein the connection pads are all arranged in the same axial position.

26. The terminal rack assembly of claim 16, wherein the plurality of electrical conductors extend in the circumferential direction over an angle of less than 120°, preferably over an angle of less than 110°, and more preferably over an angle of about 106°.

27. The terminal rack assembly of claim 16, wherein the insulating body is a plastic moulding encasing the electrical conductors at least partially with openings for the connection pads and for the connection members.

28. A stator for an electric machine, comprising:
hairpin winding conductors; and
a terminal rack assembly for a stator of an electric machine, wherein the terminal rack assembly includes:
an insulating body;
a plurality of electrical conductors having connection pads arranged to be connected to hairpin winding conductors of the stator, the plurality of electrical conductors forming at least one neutral conductor and multiple phase conductors, the phase conductors each having a connection member arranged to be connected to a current supply of the stator, the connection members being provided in one piece with the respective phase conductor;
wherein the plurality of electrical conductors is carried by the insulating body;
wherein the plurality of electrical conductors has a primary extension in a circumferential direction and a secondary extension in an axial direction; and
wherein the at least one neutral conductor and the phase conductors are arranged to overlap in a radial direction; and
wherein the hairpin winding conductors have a plurality of connection pins, wherein the connection pins are connected to the connection pads.

29. The stator of claim 28, wherein the hairpin winding conductors form at least two parallel branches per phase, each branch having a neutral connector pin and a phase connector pin at respective distal ends, wherein the neutral conductor comprises at least two electrically separate neutral conductor arms, the at least two neutral connector pins of each phase being connected to the respective separate neutral conductor arms.

30. A method of manufacturing a terminal rack assembly that includes an insulating body; a plurality of electrical conductors having connection pads arranged to be connected to hairpin winding conductors of the stator, the plurality of electrical conductors forming at least one neutral conductor and multiple phase conductors, the phase conductors each having a connection member arranged to be connected to a current supply of the stator, the connection members being provided in one piece with the respective phase conductor; wherein the plurality of electrical conductors is carried by the insulating body; wherein the plurality of electrical conductors has a primary extension in a circumferential direction and a secondary extension in an axial direction; and wherein the at least one neutral conductor and the phase conductors are arranged to overlap in a radial direction; the method comprising:
forming the plurality of electrical conductors by stamping and bending sheet metal, wherein the phase conductors are each formed in one piece with a connection member for connecting to a current supply of the stator;
arranging the at least one neutral conductor and the phase conductors such as to overlap in a radial direction; and
encasing the electrical conductors at least partially in the insulating body by plastic moulding.
